(19) United States
(12) Patent Application Publication
(10) Pub. No.: US 2020/0134232 A1
(43) Pub. Date: Apr. 30, 2020

(54) INFORMATION PROCESSING APPARATUS AND CONTROL METHOD THEREOF

(71) Applicant: CANON KABUSHIKI KAISHA, Tokyo (JP)

(72) Inventor: Yoshihisa Nomura, Kashiwa-shi (JP)

(21) Appl. No.: 16/662,803

(22) Filed: Oct. 24, 2019

(30) Foreign Application Priority Data
Oct. 31, 2018 (JP) 2018-205876

(51) Int. Cl. G06F 21/64; G06F 13/20; H04L 9/32; H04L 9/30; G06F 1/08

(52) U.S. Cl. CPC G06F 21/64; G06F 13/20; H04L 9/3242; H04L 9/30; G06F 1/08; H04L 9/3247

(57) ABSTRACT

An information processing apparatus includes a memory storing a program, a system bus, a first control unit configured to read the program via the system bus and judge whether the read program is altered, a second control unit configured to read the program judged as not being altered, from the memory via the system bus and execute the program, and a clock control unit configured to control a frequency of a clock to be supplied to a module included in the first control unit, wherein the clock control unit controls the frequency of the clock in such a manner that the frequency of the clock from a time point at which the first control unit starts reading the program to a time point at which the reading is finished is higher than the frequency of the clock after the judgement about the program.

### BACKGROUND

### Field of the Disclosure

The present disclosure relates to an information processing apparatus and a control method thereof.

### Description of the Related Art

Attacks on a vulnerability of software to alter the software in order to misuse a computer is a known issue.

WO 09/013825 discusses an information processing apparatus that includes a first central processing unit (CPU), a second CPU, and a non-volatile memory storing a program to be executed by the second CPU. In the information processing apparatus, the first CPU reads the program to be executed by the second CPU from the non-volatile memory, verifies whether the program is altered, and outputs the program to the second CPU based on the verification result. Accordingly, the second CPU executes the program that is not altered, and thus security can be improved.

### SUMMARY

In a system in which a program is read from a memory and verified whether the program is altered, the time needed to detect whether the program is altered becomes short if a clock frequency supplied to a module, such as a system bus and a central processing unit (CPU), is high. Meanwhile, the supply of a high clock frequency to the module leads to an increased amount of heat released from the module and increased power consumption thereof. A smaller amount of heat release and a lower power consumption are desirable. The present disclosure realizes a reduction in the time needed to complete verification while preventing an increase in the amount of heat release and the power consumption.

According to an aspect of the present disclosure, an information processing apparatus includes a memory storing a program, a system bus, a first control unit configured to read the program stored in the memory via the system bus and to judge whether the read program is altered, a second control unit configured to read the program judged as not being altered, from the memory via the system bus and execute the program, and a clock control unit configured to control a frequency of a clock to be supplied to the system bus and a frequency of a clock to be supplied to at least one module included in the first control unit, wherein the clock control unit controls the frequency of the clock to be supplied to the at least one module in such a manner that the frequency of the clock to be supplied to the at least one module, from a time point at which the first control unit starts reading the program to at least a time point at which the reading is finished, is higher than the frequency of the clock to be supplied to the at least one module after the judgement about the program.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a multi-function peripheral (MFP) according to a first exemplary embodiment.

FIG. 2 is a block diagram illustrating a power supply state during a process of alteration detection by a central processing unit (CPU).

FIG. 3 is a block diagram illustrating a software configuration of the MFP.

FIGS. 4A and 4B are schematic diagrams illustrating an operation at a time of activation.

FIG. 5 is a flowchart illustrating a process according to the first exemplary embodiment.

FIG. 6 is a flowchart illustrating a process according to the first exemplary embodiment.

FIG. 7 is a block diagram illustrating a hardware configuration of an MFP according to a second exemplary embodiment.

FIG. 8 is a flowchart illustrating a process according to the second exemplary embodiment.

### DESCRIPTION OF THE EMBODIMENTS

Exemplary embodiments of the present disclosure will be described in detail below with reference to the attached drawings. It should be noted that the present disclosure is not limited to the below-described exemplary embodiments and that not every combination of features described below is always essential to a technical solution of the present disclosure. Further, while a multi-function peripheral (MFP) (e.g., digital MFP) is described below as an example of an information processing apparatus according to an exemplary embodiment of the present disclosure, applications of the present disclosure are not limited to the MFP, and the present disclosure can be applied to any information processing apparatus.

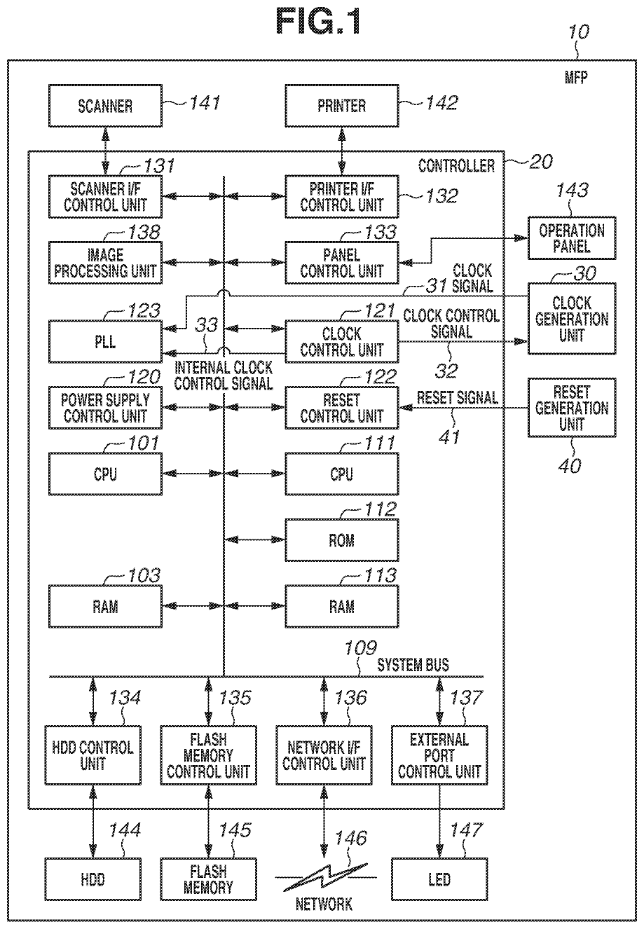

FIG. 1 is a block diagram illustrating a hardware configuration of a MFP 10 according to a first exemplary embodiment.

A controller 20 includes hardware modules 101 to 137 for controlling the MFP 10, which will be described below. In the present exemplary embodiment, the hardware modules 101 to 137 will be described as integrated in one or more semiconductor chips.

A clock generation unit 30 generates a clock and supplies a clock signal (external clock) of a frequency suitable for each module included in the MFP 10. In the present exemplary embodiment, the clock generation unit 30 supplies a clock signal 31 to a phase locked loop (PLL) 123 included in the controller 20. The PLL 123 functions as a clock supply unit configured to supply a clock with a variable frequency. The frequency of the clock generation unit 30 is changeable by a clock control signal 32.

A reset generation unit 40 is a semiconductor chip configured to generate a reset signal to reset each module included in the MFP 10. While only a reset signal 41 output to the controller 20 is illustrated in the present exemplary embodiment, the reset signal may also be output to other modules, such as a scanner 141 and a printer 142. If power is supplied to the MFP 10, the reset signal 41 is maintained asserted for a predetermined period of time (e.g., until a supplied power voltage becomes stable), and thereafter the reset signal 41 is deasserted to deassert reset of the controller 20. If the reset of the controller 20 is deasserted, the modules included in the controller 20 start operating.

A central processing unit (CPU) 101 executes a software program of the MFP 10 and controls the entire apparatus.

A random access memory (RAM) 103 is used to store a program and temporary data when the CPU 101 controls the MFP 10.

A hard disk drive (HDD) 144 stores part of programs and various types of data. The HDD 144 stores a Java® program 214 to be executed by the CPU 101.

A flash memory 145 stores, for example, a predetermined parameter of the MFP 10. The flash memory 145 stores a basic input/output system (BIOS) 210 to be executed by the CPU 101. The flash memory 145 further stores a loader 211, a kernel 212, and a native program 213 to be executed by the CPU 101. The HDD 144 and the flash memory 145 can be the same storage module.

A CPU 111 executes an alteration detection software program to detect an alteration in a software program to be executed by the CPU 101, and performs part of the control of the MFP 10.

A read-only memory (ROM) 112 stores, for example, the alteration detection software program and a public key described below. The ROM 112 further stores a boot program 209 to be executed by the CPU 111.

The ROM 112 is a mask ROM, which does not permit rewriting of data content, or a one-time programmable (OTP) ROM, which permits writing only once at the time of manufacturing.

A RAM 113 is a random access memory used to store a program and/or temporary data when the CPU 111 controls the MFP 10. The RAMs 103 and 113 may be the same module.

A power supply control unit (power control unit) 120 is an integrated circuit (IC) configured to control power supply to the modules included in the controller 20. The power supply control unit 120 can supply a predetermined amount of power to each of the modules or stop the power supply when the controller 20 (MFP 10) is activated or operated.

A clock control unit 121 controls the PLL 123 using an internal clock control signal 33. Thus, the PLL 123 multiplies the frequency of the clock signal 31 and supplies the multiplied clock signals to the modules included in the controller 20. The clock control unit 121 changes a setting of the multiplication with respect to the PLL 123 when the controller 20 is activated or operated, thereby performing control so that the PLL 123 supplies a clock (internal clock) with an optimum frequency to each of the modules. Further, the clock control unit 121 can gate and stop the clock independently for each module.

A reset control unit 122 resets the module units included in the controller 20. The reset control unit 122 resets or deasserts reset of each module when the controller 20 is activated or operated.

A scanner interface (I/F) control unit 131 performs control of document reading performed by the scanner 141. A printer I/F control unit 132 performs control, for example, of printing processing performed by the printer 142. A panel control unit 133 performs control of an operation panel 143, which is a touch panel, and controls display of various types of information and an input instruction from a user.

A HDD control unit 134 performs control of reading and writing of data from and to the HDD 144. The HDD control unit 134 can read image data stored in, for example, the RAM 103 and store the image data into the HDD 144 via a system bus 109.

A flash memory control unit 135 performs control to read and write data from and to the flash memory 145. The flash memory control unit 135 can read a program stored in the flash memory 145 and develops the read program onto the RAM 113 via the system bus 109 at the time of activation of the controller 20.

A network I/F control unit 136 performs control of transmission and reception of data to and from another device or a server on a network 146.

An external port control unit 137 performs control of input and output ports of the controller 20. For example, the external port control unit 137 controls an output port to thereby turn on a light-emitting diode (LED) 147 as needed for external notification of an abnormality in software or hardware.

An image processing unit 138 is a processing unit configured to perform shading correction on image data read from the scanner 141 and to perform halftone processing and smoothing processing on the image data in order to output the image data to the printer 142.

The system bus 109 connects the modules connected to the system bus 109 to one another. Control signals from the CPUs 101 and 111 or data signals between the apparatuses are transmitted and received via the system bus 109.

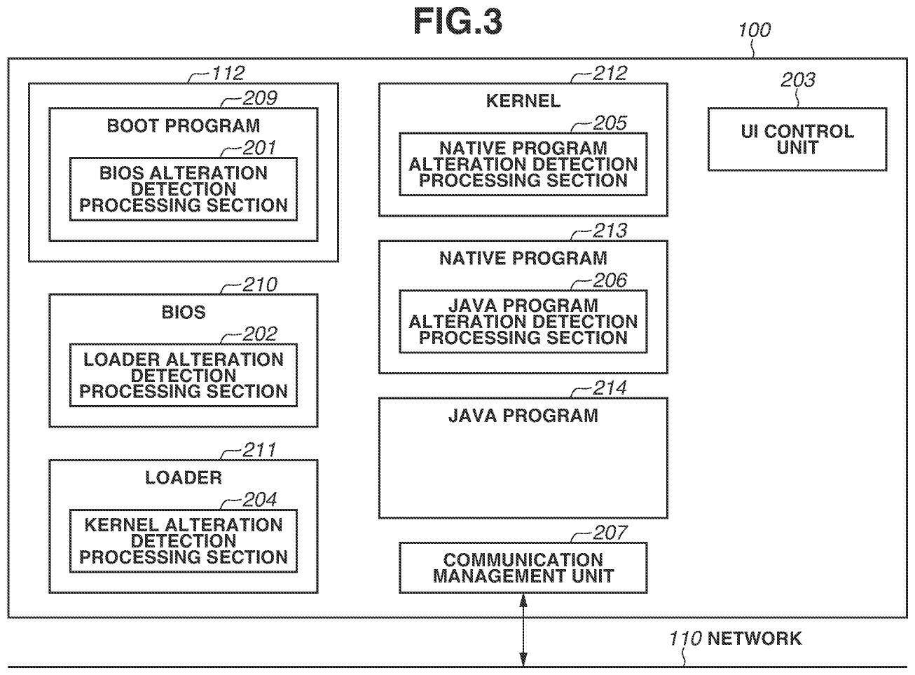

FIG. 3 is a block diagram illustrating software modules of the MFP 10 according to the first exemplary embodiment. The software is to be executed by the CPU 101 or 111 in the following description.

A communication management unit 207 controls a network I/F control unit 136 connected to the network 146 to externally transmit and receive data via the network 146.

A user interface (UI) control unit 203 receives input to the operation panel 143 via the panel control unit 133, performs processing based on the input, and outputs a screen to the operation panel 143.

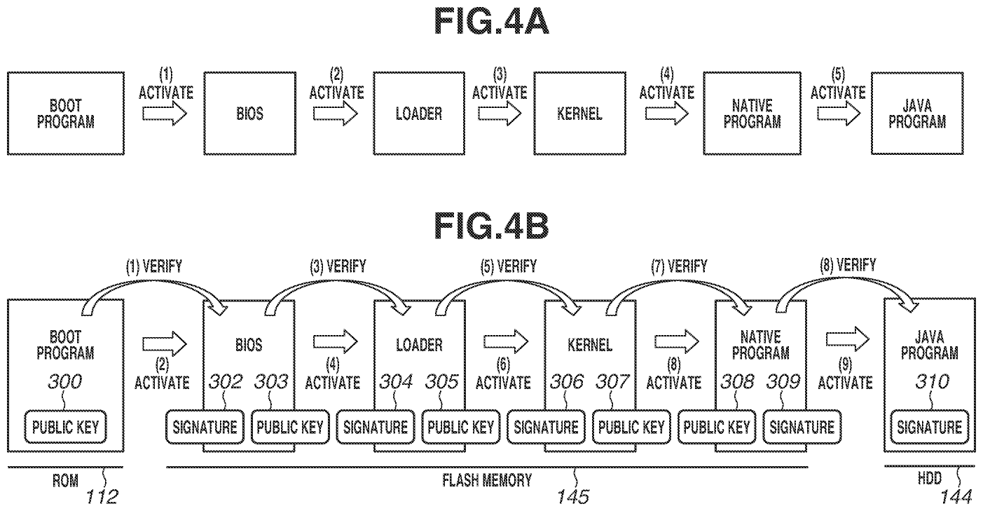

The boot program 209 is a program executed by the CPU 111 when the MFP 10 is turned on, and an activation sequence is executed with respect to the controller 20 as activation-related processing. The activation sequence will be described below with reference to FIGS. 4A and 4B. The boot program 209 includes a BIOS alteration detection processing section 201 for executing alteration detection on the BIOS 210 after the activation.

The BIOS 210 is a program that is executed by the CPU 101 after the boot program 209 is executed. The BIOS 210 includes a loader alteration detection processing section 202 to execute activation-related processing and alteration detection on the loader 211.

The loader 211 is a program that is executed by the CPU 101 after the processing performed by the BIOS 210 ends. The loader 211 includes a kernel alteration detection processing section 204 to execute activation-related processing and alteration detection on the kernel 212.

The kernel 212 is a program that is executed by the CPU 101 after the processing of the loader 211 ends. The kernel 212 includes a native program alteration detection processing section 205 to execute activation-related processing and alteration detection on the native program 213.

The native program 213 is a program that is executed by the CPU 101, and includes a plurality of programs configured to cooperate with the Java program 214 stored in the MFP 10 to provide a function. The plurality of programs includes, for example, a program to control the scanner IF control unit 131 or the printer IF control unit 132 and an activation program. The activation program is read from the native program 213 by the kernel 212, and the activation processing is performed. The native program 213 further includes a Java program alteration detection processing section 206 for executing alteration detection on the Java program 214 as one of the programs.

The Java program 214 is a program that is executed by the CPU 101, and is configured to provide each function in cooperation with the native program 213 installed in the MFP 10 (e.g., the Java program 214 to display a screen on the operation panel 143).

Next, the activation sequence of the MFP 10 will be described with reference to FIGS. 4A and 4B.

FIG. 4A is a schematic diagram illustrating the activation sequence that specifies an order in which the MFP 10 is activated without performing alteration detection. The boot program 209 activates the BIOS 210, the BIOS 210 activates the loader 211, the loader 211 activates the kernel 212, and the kernel 212 activates the activation program of the native program 213. During the activation program, the Java program 214 is activated, and thereafter the native program 213 and the Java program 214 cooperate to provide each function installed in the MFP 10.

FIG. 4B is a schematic diagram illustrating the activation sequence that specifies a process by which the boot program 209, the BIOS 210, the loader 211, the kernel 212, the native program 213, and the Java program 214 are activated while alteration detection is performed thereon. The schematic diagram in FIG. 4B also specifies a storage location of each program, digital signature (hereinafter, referred to as “signature”), and public key.

The signature is, for example, a value obtained by converting a normal program (data string) into a hash value using a predetermined hash function and encrypting the hash value using a private key that corresponds to a public key. The encrypted hash value is decrypted using the public key to thereby calculate the hash value of the normal program, and a program that is an alteration verification target is converted into a hash value using the above-described hash function. The two hash values are then compared. If the two hash values are equal, it is judged that the verification target program is not altered from the normal program. On the other hand, if the two hash values are different, it is judged that the verification target program is altered from the normal program. The method to check whether a verification target program is altered by using a signature as described above will be referred to as “program signature verification” hereinafter. A situation that a program is not altered will be referred to as “signature verification is successful”, whereas a situation that a program is altered will be referred to as “signature verification is unsuccessful”. While the method using the signature and the public key is employed as a method for checking whether a program is altered in the present exemplary embodiment, any other method can be employed to check the presence of an alteration.

The ROM 112 stores the boot program 209 and a public key 300 for BIOS signature verification. The flash memory 145 stores the BIOS 210, the loader 211, the kernel 212, the native program 213, and the Java program 214. The flash memory 145 further stores a BIOS signature 302, a public key 303 for loader verification, a loader signature 304, a public key 305 for kernel verification, a kernel signature 306, and a public key 307 for native program verification. A native program signature 309, a public key 308 for Java program verification, and a Java program signature 310 are also stored in the flash memory 145. The public keys and the signatures are stored in advance in the ROM 112 and the flash memory 145 before the MFP 10 is shipped.

The alteration detection processing sections 201, 202, 204, 205, and 206 verify whether a next program is altered, and if the verified program is not altered, the next program is activated. The MFP 10 is activated according to the activation sequence in which the programs sequentially undergo alteration detection and activation.

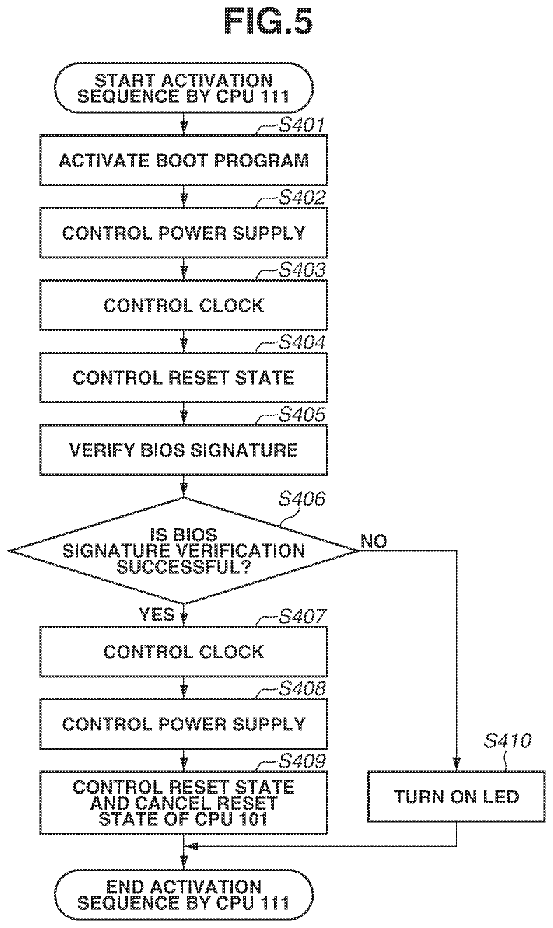

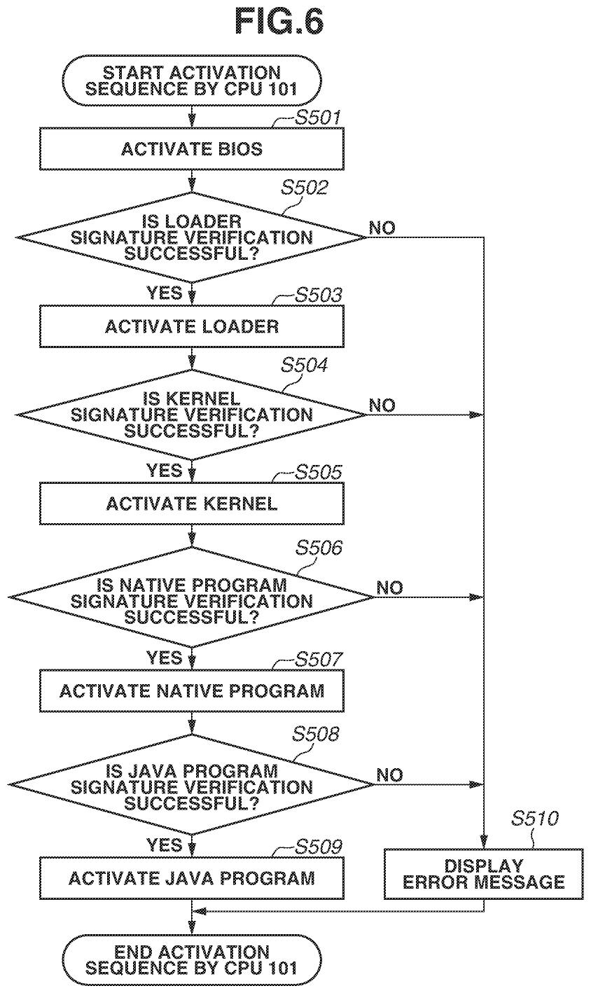

A method for operating a frequency at a maximum speed at the time of executing an alteration detection program in the activation sequence, which is a feature of the present exemplary embodiment, will be described with reference to FIGS. 5 and 6.

FIG. 5 is a flowchart illustrating a process of the activation sequence that is executed by the CPU 111. FIG. 6 is a flowchart illustrating a process of the activation sequence that is executed by the CPU 101.

In the present exemplary embodiment, an operation is performed under the below-described setting in an initial state and then the process illustrated in the flowchart in FIG. 5 is executed.

If the MFP 10 is turned on, the power supply control unit 120 performs control to supply power to the components of the controller 20. If power is supplied to the clock control unit 121, the clock control unit 121 outputs the clock control signal 32 to the clock generation unit 30 to thereby perform control so that an oscillator or vibrator of the clock generation unit 30 generates the clock signal 31. The clock control unit 121 outputs the internal clock control signal 33 to the PLL 123 to thereby perform control so that the PLL 123 generates a desired internal clock of the controller 20. In a default state when power is input, the multiplication function of the PLL 123 is not in operation, and the clock signal 31 is bypassed and output as an internal clock. Thus, the frequency of the internal clock is low and about 1/10 the frequency during normal operation.

Next, the reset generation unit 40 deasserts reset of the reset control unit 122 via the reset signal 41.

If the reset of the reset control unit 122 is deasserted, the reset control unit 122 first deasserts the reset of the CPU 111, the ROM 112, and the system bus 109. At this time, reset of the CPU 101 still remains deasserted. Further, a reset vector of the CPU 111 is an address of the ROM 112. Specifically, if the reset of the CPU 111 is deasserted, the CPU 111 executes the program stored in the ROM 112. A reset vector of the CPU 101 is an address of the flash memory 145. If the reset of the CPU 101 is deasserted, the CPU 101 executes the program stored in the flash memory 145.

The activation sequence of steps S401 to S410 executed by the CPU 111 will be described with reference to FIG. 5. Specifically, the below-described process is performed by the software modules illustrated in FIG. 3 and executed by the CPU 111. A feature of the activation sequence is executed in steps S402, S403, S407, and S408. Specifically, during the process to judge whether a program is altered (hereinafter, the process will be referred to as an “alteration detection process”), a high-frequency clock is supplied to at least one of the modules involved in the alteration detection process, and power is supplied to only some of the modules included in the controller 20. Examples of the modules involved in the alteration detection process include the CPU 111 and the system bus 109. After the alteration detection process (FIG. 5), power is supplied to all the modules included in the controller 20 and a low-frequency clock is supplied to the at least one of the modules. For example, the clock control unit 121 controls the PLL 123 so that a high-frequency clock is supplied to the CPU 111 and the system bus 109 from a time point at which the CPU 111 starts reading the BIOS 210 from the ROM 112 to at least a time point at which the CPU 111 finishes reading the BIOS 210. Further, the clock control unit 121 controls the PLL 123 so that a low-frequency clock is supplied to the CPU 111 and the system bus 109 after the CPU 111 executes the alteration detection process performed by the BIOS 210.

In step S401, if the reset of the CPU 111 is deasserted, the CPU 111 reads the boot program 209 stored in the ROM 112 via the system bus 109 and executes the read boot program 209.

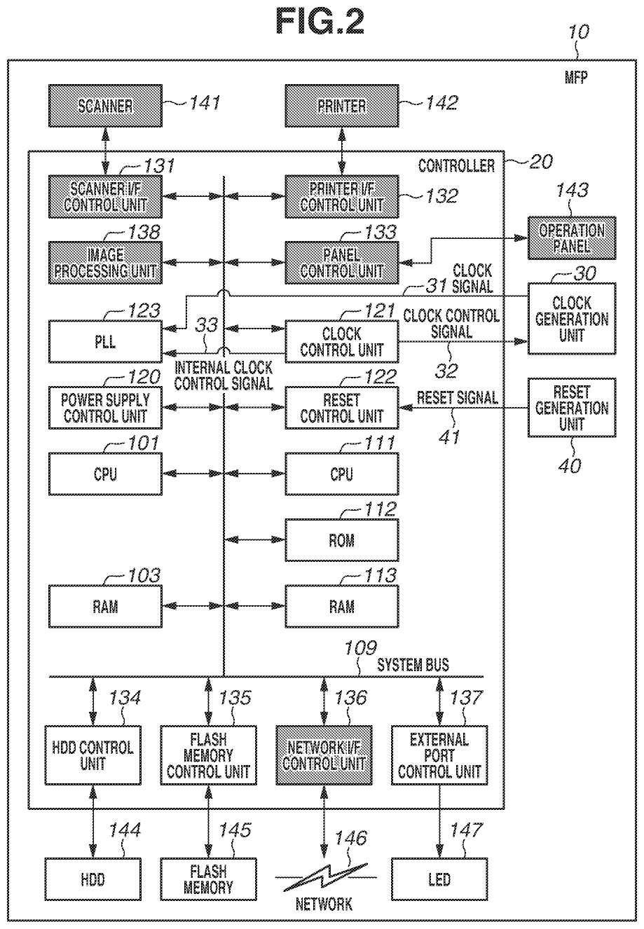

In step S402, the CPU 111 performs power supply control (power control) according to the boot program 209. In step S402, the CPU 111 performs control in such a manner that power is supplied only to some of the modules included in the controller 20 that are needed to perform alteration detection. In the present exemplary embodiment, power is supplied at least to the modules that are needed in the alteration detection process, such as clock control unit 121, the reset control unit 122, the PLL 123, and the power supply control unit 120. Power is also supplied to the CPU 101, the RAM 103, the CPU 111, the ROM 112, the RAM 113, the HDD control unit 134, the flash memory control unit 135, the flash memory 145, and the external port control unit 137. Power is not supplied to the modules that are shown in gray in FIG. 2.

In step S403, the CPU 111 performs clock control described below according to the boot program 209. After the activation of the controller 20 is completed, the operation frequency of each module included in the controller 20 changes depending on the product specifications of the MFP 10. However, in order to reduce the activation time, the frequency of a clock supplied to the modules (e.g., the CPU 111 and the system bus 109) involved in the alteration detection process is desirably set to a high frequency while the alteration detection process is executed.

Thus, in the present exemplary embodiment, the clock control unit 121 instructs, using the clock control signal 32, the clock generation unit 30 to supply the clock signal 31 with a high frequency. In a case where the external clock is changed, it is required to wait until a crystal vibrator and a crystal oscillator become stable.

The clock control unit 121 controls the PLL 123 using the internal clock control signal 33 so that the frequency of the internal clock supplied to the necessary modules included in the controller 20 is set to a high frequency. This enables the CPU 111, the system bus 109, and the flash memory control unit 135 to perform processing at high speed.

The clock control unit 121 performs the below-described processing to change the frequency of the internal clock. Specifically, the clock control unit 121 performs control so as to temporarily gate the clock from the PLL 123, switch to the external clock that has bypassed the PLL 123, and then supply the internal clock for high-speed operation to each module after the internal clock generated by the PLL 123 becomes stable. Since the control to switch the internal clock also stops the clock supply to the CPU 111, the control is performed with a hardware sequencer provided in the clock control unit 121.

The clock control unit 121 performs setting of the clock frequencies to be supplied to the CPU 101, the RAM 103, the CPU 111, the ROM 112, the RAM 113, the system bus 109, the HDD control unit 134, the flash memory control unit 135, and the flash memory 145. Each of the set clock frequencies is higher than a frequency set in step S407 described below. The frequency of each clock to be supplied may be set differently for each module to which the clock is to be supplied. For example, the clocks of different frequencies may be supplied, e.g., a 150-MHz clock to the CPU 111 and a 600-MHz clock to the system bus 109. These clocks minimize the time needed to execute the below-described processing. Especially, the BIOS 210, the loader 211, and the kernel 212 to be read from the flash memory 145 are large in data amount, so that the reading or encryption/decryption processing for alteration detection processing may significantly affect the activation time. Accordingly, the activation time can be reduced by maximizing the operation frequency of the system bus 109 and the operation frequency of the flash memory control unit 135 and the CPU 111.

In step S404, the CPU 111 deasserts the reset based on the boot program 209. The CPU 111 deasserts the reset of the modules needed in the alteration detection process. Specifically, reset of the RAM 113, the HDD control unit 134, the flash memory control unit 135, and the flash memory 145 is deasserted.

In step S405, the CPU 111 verifies the signature of the BIOS 210 based on the boot program 209. The BIOS alteration detection processing section 201 included in the boot program 209 reads the BIOS 210 and the BIOS signature 302 from the flash memory 145, and writes the BIOS 210 and the BIOS signature 302 into the RAM 113 via the system bus 109. Next, the BIOS alteration detection processing section 201 verifies the BIOS signature 302 using the public key 300 to be used for BIOS signature verification.

In step S406, the CPU 111 judges whether the verification of the signature of the BIOS 210 is successful. As a result of the signature verification, if the BIOS 210 is not altered (if the hash value and the value of the signature match), the CPU 111 judges that the signature verification is successful (YES in step S406), and the processing proceeds to step S407. On the other hand, if the BIOS 210 is altered (if the hash value and the value of the signature do not match), the CPU 111 judges that the signature verification is unsuccessful (NO in step S406), and the processing proceeds to step S410.

In step S407, the CPU 111 controls the clock control unit 121 to change the frequency of the clock supplied by the PLL 123 from the high frequency set in step S403 to a relatively low operation frequency corresponding to the product specifications of the MFP 10. The frequency of each clock to be supplied may be set differently for each module to which the clock is to be supplied. For example, a 100-MHz clock may be supplied to the CPU 111 and a 400-MHz clock to the system bus 109. A method to change the operation frequency is similar to the method in step S403 described above, so that description thereof is omitted.

In step S408, the CPU 111 controls the power supply control unit 120 so that power is supplied to all the modules included in the controller 20.

In step S409, the CPU 111 controls the reset control unit 122 to deassert the reset of the CPU 101 and the RAM 103, and the processing of the boot program 209 ends. The activation sequence then proceeds to step S501 described below. Specifically, the CPU 101 executes the BIOS 210 and the BIOS 210 is activated.

In step S410, the BIOS alteration detection processing section 201 (CPU 111) controls the external port control unit 137 to turn on the LED 147 for notification of the unsuccessful signature verification in step S406, and the processing of the boot program 209 ends.

The control in step S407 may be executed using the BIOS 210 or the kernel 212 that corresponds to a program described below to be executed by the CPU 101. In this way, the activation sequence of the CPU 101 is operated with a frequency for high-speed operation and, the activation time is further reduced. Since some product specifications have a power capacity and a heat capacity, the clock control and the power supply control are performed within a frequency range in which high-speed operation is guaranteed.

The CPU 101 executes the above-described sequence so that the BIOS 210 that is not altered is executed.

The activation sequence that is executed by the CPU 101 will be described below in steps S501 to S510 with reference to FIG. 6. The below-described process is performed by the software modules (illustrated in FIG. 3) executed by the CPU 101. A method to judge whether an alteration is detected in a program (e.g., the loader 211, the kernel 212, the native program 213, and the Java program 214) in the description below is a mere example, and a different method to detect an alteration in a program can be used.

In step S501, if the BIOS 210 is activated from the flash memory 145 via the system bus 109, the CPU 101 performs various types of initialization processing. At this time, the loader alteration detection processing section 202, which is included in the BIOS 210, reads the loader 211, the public key 305 for kernel verification, and the loader signature 304 from the flash memory 145, and writes the loader 211, the public key 305 for kernel verification, and the loader signature 304 to the RAM 103. In an initialization sequence herein, for example, the HDD control unit 134 is initialized to enable access to the HDD 144.

In step S502, the loader alteration detection processing section 202 verifies the signature of the loader 211 using the public key 303 for loader verification and the loader signature 304, and judges whether the signature verification is successful. If the signature verification is unsuccessful (NO in step S502), then in step S510, the loader alteration detection processing section 202 initializes the panel control unit 133 and displays an error message on the operation panel 143, and the process ends. On the other hand, if the signature verification is successful (YES in step S502), the loader alteration detection processing section 202 ends processing, and the BIOS 210 activates the loader 211 that has been written to the RAM 103.

In step S503, if the loader 211 is activated, the loader 211 performs various types of initialization processing. In the initialization herein, for example, the panel control unit 133 is initialized and an activation screen is displayed on the operation panel 143. Further, the kernel alteration detection processing section 204 included in the loader 211 reads out the kernel 212, the public key 307 for native program verification, and the kernel signature 306, from the flash memory 145. The kernel alteration detection processing section 204 then writes the kernel 212, the public key 307 for native program verification, and the kernel signature 306 to the RAM 103.

In step S504, the kernel alteration detection processing section 204 verifies the signature of the kernel 212 using the public key 305 for kernel verification and the kernel signature 306, and judges whether the signature verification is successful. If the signature verification is unsuccessful (NO in step S504), then in step S510, the kernel alteration detection processing section 204 displays an error message on the operation panel 143, and the process ends. On the other hand, if the signature verification is successful (YES in step S504), the kernel alteration detection processing section 204 ends processing, and the loader 211 activates the kernel 212 that has been written to the RAM 103.

In step S505, if the kernel 212 is activated, the kernel 212 performs various types of initialization processing. In the initialization herein, for example, the network I/F control unit 136 is initialized to enable communication with the network 146. Next, the native program alteration detection processing section 205 included in the kernel 212 reads the native program 213, the public key 307 for Java program verification for the Java program 214, and the native program signature 309 from the flash memory 145, and writes the native program 213, the public key 307 for Java program verification for the Java program 214, and the native program signature 309 to the RAM 103.

In step S506, the native program alteration detection processing section 205 verifies the signature of the native program 213 using the public key 307 for verification and the native program signature 309 and judges whether the signature verification is successful. If the signature verification is unsuccessful (NO in step S506), then in step S510, the native program alteration detection processing section 205 displays an error message on the operation panel 143, and the process ends. On the other hand, if the signature verification is successful (YES in step S506), the native program alteration detection processing section 205 ends processing and activates the native program 213.

In step S507, if the Java program alteration detection processing section 206, which is included in the native program 213 and performs alteration detection processing, is activated, the Java program alteration detection processing section 206 reads the Java program 214 and the Java program signature 310 from the HDD 144, and writes the Java program 214 and the Java program signature 310 to the RAM 103.

In step S508, the Java program alteration detection processing section 206 verifies the signature of the Java program 214 using the public key 308 for Java program verification and the Java program signature 310, and judges whether the signature verification is successful. If the signature verification is unsuccessful (NO in step S508), then in step S510, the Java program alteration detection processing section 206 displays an error message on the operation panel 143, and the process ends. On the other hand, if the signature verification is successful (YES in step S508), the Java program alteration detection processing section 206 ends processing. In step S509, the Java program alteration detection processing section 206 activates the Java program 214.

While the processing in step S510 displays the error message on the operation panel 143, instead of displaying the error message, the LED 147 may be turned on by controlling the external port control unit 137 as in step S410. Alternatively, the error message may be displayed on the operation panel 143 while the LED 147 is turned on.

As described above, according to the first exemplary embodiment, the boot program 209 executes the process of detecting an alteration in the BIOS 210 at high speed so that the activation time is reduced.

In the present exemplary embodiment, the clock control is performed while the boot program 209 executes the process of changing from the maximum frequency to the normal operation frequency according to the product specifications of the MFP 10. The program to perform the clock control is not limited to that in the present exemplary embodiment, and the BIOS 210 or the kernel 212 may perform the clock control.

Although all the public keys are described as different keys in the present exemplary embodiment, the public keys may include the same public key. The storage locations of the programs other than the boot program 209 are not limited and may be another storage medium. Further, the storage locations of the programs may be different from those described above. The loader 211 may be stored in, for example, the ROM 112.

A second exemplary embodiment will be described. In the first exemplary embodiment, the controller 20 is configured using a single large-scale integrated (LSI) circuit. In a method according to the second exemplary embodiment, a dedicated chip configured to perform alteration detection at the time of activation is used. Only a difference from the first exemplary embodiment will be described.

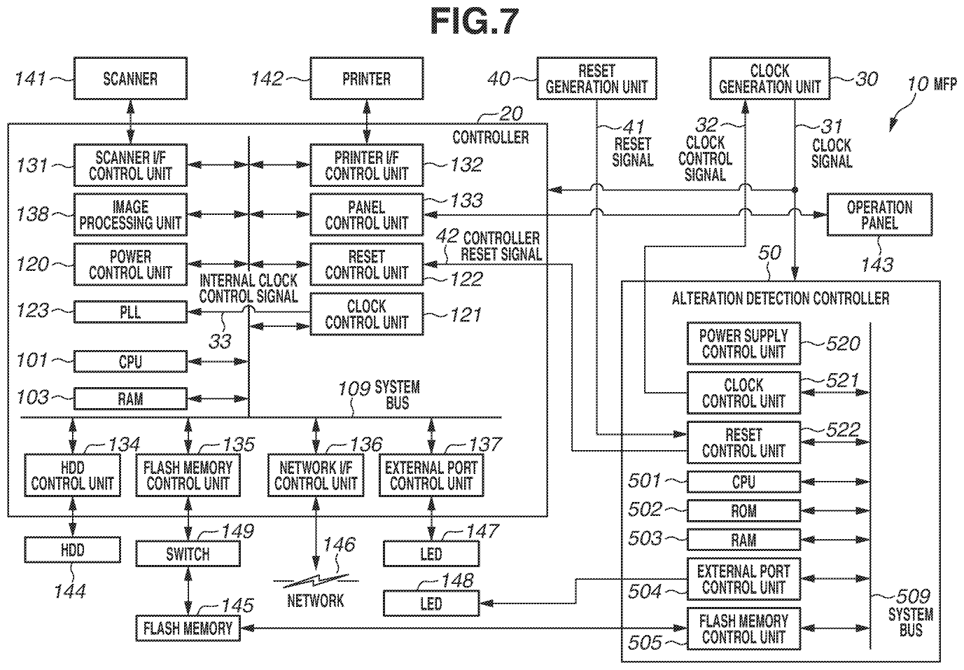

FIG. 7 illustrates a hardware block configuration of the MFP 10 according to the present exemplary embodiment. A difference from the first exemplary embodiment is that an alteration detection controller 50 is an integrated circuit (IC). The alteration detection controller 50 includes a CPU 501, a ROM 502, a RAM 503, an LED 148, and a system bus 509, which respectively correspond to the CPU 111, the ROM 112, the RAM 113, the LED 147, and the system bus 109 included in the controller 20 according to the first exemplary embodiment. The alteration detection controller 50 further includes a power supply control unit 520, a clock control unit 521, a reset control unit 522, an external port control unit 504, and a flash memory control unit 505.

The clock control signal 32 for controlling a clock generation unit 30 and a controller reset signal 42 to deassert the reset of the controller 20 are connected to the alteration detection controller 50. The alteration detection controller 50 is also connected to the flash memory 145 and the LED 148. The controller 20 and the alteration detection controller 50 cannot simultaneously access the flash memory 145, so that a switch 149 performs access control. Specifically, the switch 149 prohibits the alteration detection controller 50 from accessing the flash memory 145 while the controller 20 accesses the flash memory 145. The switch 149 prohibits the controller 20 from accessing the flash memory 145 while the alteration detection controller 50 accesses the flash memory 145.

In the present exemplary embodiment, an operation is performed under the below-described setting in the initial state.

If the MFP 10 is turned on, the power supply control unit 520 performs control so that power is supplied to the clock control unit 521, the reset control unit 522, the CPU 501, the ROM 502, and the RAM 503. The reset generation unit 40 deasserts reset of the alteration detection controller 50 via the reset signal 41. If power is supplied to the clock control unit 521, the clock control unit 521 performs control so that the oscillator or vibrator of the clock generation unit 30 included in the MFP 10 and the PLL 123 included in the controller 20 (not illustrated) each generates a predetermined clock. If the reset of the alteration detection controller 50 is deasserted, the reset control unit 522 deasserts reset of the CPU 501. A reset vector of the CPU 501 is set to an address of the ROM 502, and if the reset of the CPU 501 is deasserted, the CPU 501 first executes a program stored in the ROM 502. Meanwhile, if the reset of the controller 20 is deasserted via the controller reset signal 42, the reset control unit 122 deasserts the reset of the CPU 101. If the reset vector of the CPU 101 is set to the address of the flash memory 145, the CPU 101 after the reset is deasserted first executes the program stored in the flash memory 145.

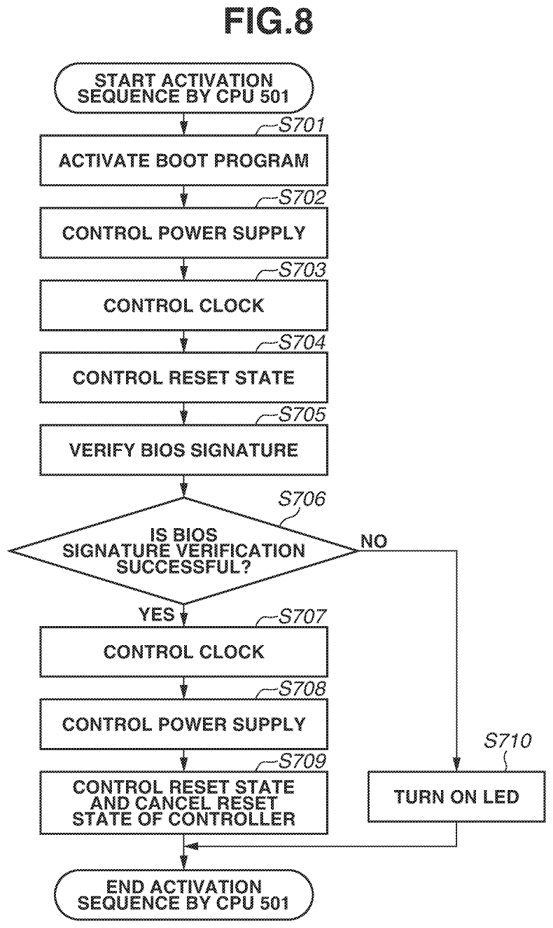

FIG. 8 illustrates an activation sequence using the dedicated chip configured to perform alteration detection. In the description below, the CPU 501 executes steps S701 to S710. Since the steps other than step S709 are similar to those in the first exemplary embodiment, description thereof is omitted. Specifically, steps S701 to S708 and S710 are similar to steps S401 to S408 and S410, respectively. The CPU 111, the ROM 112, and the RAM 113 that are modules included in the controller 20 in steps S401 to S410 correspond to the CPU 501, the ROM 502, and the RAM 503 which are modules included in the alteration detection controller 50. The flash memory control unit 135, the external port control unit 137, and the system bus 109 correspond to the flash memory control unit 505, the external port control unit 504, and the system bus 509, respectively. The power supply control unit 120, the clock control unit 121, and the reset control unit 122 correspond to the power supply control unit 520, the clock control unit 521, and the reset control unit 522, respectively.

In step S709, the CPU 501 controls the reset control unit 522 to thereby deassert reset of the controller reset signal 42 with respect to the controller 20, and the processing of the boot program 209 ends.

As described above, according to the second exemplary embodiment, the activation sequence from steps S701 to S710 enables high-speed execution of the alteration detection processing on the BIOS 210 by the boot program 209, so that the activation time is reduced.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-205876, filed Oct. 31, 2018, which is hereby incorporated by reference herein in its entirety.

What is claimed is:

1. An information processing apparatus comprising:
a memory storing a program;
a system bus;
a first control unit configured to read the program stored in the memory via the system bus and judge whether the read program is altered;
a second control unit configured to read the program judged as not being altered, from the memory via the system bus and execute the program; and
a clock control unit configured to control a frequency of a clock to be supplied to the system bus and a frequency of a clock to be supplied to at least one module included in the first control unit,
wherein the clock control unit controls the frequency of the clock to be supplied to the at least one module in such a manner that the frequency of the clock to be supplied to the at least one module, from a time point at which the first control unit starts reading the program to at least a time point at which the reading is finished, is higher than the frequency of the clock to be supplied to the at least one module after the judgement about the program.

2. The information processing apparatus according to claim 1, wherein the clock control unit controls the frequency of the clock to be supplied to the system bus and the frequency of the clock to be supplied to the first control unit in such a manner that the frequency of the clock to be supplied to the system bus and the frequency of the clock to be supplied to the first control unit, from the time point at which the first control unit starts reading the program to at least the time point at which the reading is finished, are respectively higher than the frequency of the clock to be supplied to the system bus and the frequency of the clock to be supplied to the first control unit after the judgement about the program.

3. The information processing apparatus according to claim 1, wherein the frequency of the clock to be supplied to the system bus and the frequency of the clock to be supplied to the first control unit are different.

4. The information processing apparatus according to claim 3, wherein the frequency of the clock to be supplied to the system bus is higher than the frequency of the clock to be supplied to the first control unit.

5. The information processing apparatus according to claim 1, further comprising a clock supply unit configured to supply the clock to the system bus and the at least one module included in the first control unit,
wherein the clock control unit sets, to the clock supply unit, the frequency of the clock to be supplied by the clock supply unit and controls the frequency of the clock.

6. The information processing apparatus according to claim 1, further comprising a power control unit configured to control supply of power to the first control unit and the second control unit,
wherein the power control unit supplies power to the first control unit and does not supply power to the second control unit from the time point at which the first control unit starts reading the program to a time point at which the judgement is finished, and after the judgement is finished, the power control unit supplies power to the first control unit and the second control unit.

7. The information processing apparatus according to claim 1,
wherein the memory stores a signature of the program that is encrypted with a private key,
wherein the first control unit includes
a calculation unit configured to calculate the signature of the program read from the memory via the system bus,
a reading unit configured to read the encrypted signature from the memory, and
a decryption unit configured to decrypt the read encrypted signature with a public key, and
wherein the first control unit judges whether the program stored in the memory is altered, by comparing the calculated signature and the decrypted signature.

8. The information processing apparatus according to claim 7, wherein the signature is a hash value of the program.

9. An information processing apparatus comprising:
a memory storing a program;
a system bus;
a clock control unit configured to control a frequency of a clock to be supplied to read data via the system bus;
a clock supply unit configured to supply the clock having the frequency controlled by the clock control unit;
a first control unit configured to read the program stored in the memory via the system bus and to verify the read program; and
a second control unit configured to read the program judged as not being altered by the verification, from the memory via the system bus and to execute the read program,
wherein the clock control unit controls the frequency of the clock to be supplied by the clock supply unit to read the data via the system bus in such a manner that the frequency of the clock to be supplied by the clock supply unit to read the data via the system bus, from at least a time point at which the first control unit starts reading the program via the system bus to a time point at which the reading is finished, is higher than the frequency of the clock to be supplied by the clock supply unit to read the data via the system bus after the program is judged as not being altered by the verification.

10. A method of controlling an information processing apparatus including a memory storing a program,
a system bus,
a first control unit configured to read the program stored in the memory via the system bus and judge whether the read program is altered, and
a second control unit configured to read the program judged as not being altered from the memory via the system bus and execute the program,
the method comprising:
supplying a clock to the system bus and a clock to the first control unit,
wherein the supplying includes controlling a frequency of the clock to be supplied to the system bus and a frequency of the clock to be supplied to the first control unit in such a manner that the frequency of the clock to be supplied to the system bus and the frequency of the clock to be supplied to the first control unit, from a time point at which the first control unit starts reading the program to at least a time point at which the reading is finished, are higher than the frequency of the clock to be supplied to the system bus and the frequency of the clock to be supplied to the first control unit, respectively, after the judgement about the program.

11. The method according to claim 10, wherein the controlling controls the frequency of the clock to be supplied to the system bus and the frequency of the clock to be supplied to the first control unit in such a manner that the frequency of the clock to be supplied to the system bus and the frequency of the clock to be supplied to the first control unit, from the time point at which the first control unit starts reading the program to at least the time point at which the reading is finished, are higher than the frequency of the clock to be supplied to the system bus and the frequency of the clock to be supplied to the first control unit, respectively, after the judgement about the program.

12. The method according to claim 10, wherein the frequency of the clock to be supplied to the system bus and the frequency of the clock to be supplied to the first control unit are different.

13. The method according to claim 12, wherein the frequency of the clock to be supplied to the system bus is higher than the frequency of the clock to be supplied to the first control unit.

14. The method according to claim 10,
wherein the information processing apparatus further includes a clock supply unit configured to generate the clock to be supplied to the system bus and the clock to be supplied to the first control unit, and
wherein the controlling sets the frequencies of the clocks to be supplied to the clock supply unit, and controls the frequencies.

15. The method according to claim 10, further comprising controlling supply of power to the first control unit and the second control unit,
wherein the controlling supplies power to the first control unit and does not supply power to the second control unit from the time point at which the first control unit starts reading the program to a time point at which the judgement is finished, and after the judgement is finished, the controlling supplies power to the first control unit and the second control unit.

16. The method according to claim 10,
wherein the memory stores a signature of the program that is encrypted with a private key,
wherein the judgement by the first control unit includes
calculating a signature of the program read from the memory via the system bus,
reading the encrypted signature from the memory, and
decrypting the read encrypted signature with a public key, and
wherein the first control unit judges whether the program stored in the memory is altered, by comparing the calculated signature and the decrypted signature.

17. The method according to claim 16, wherein the signature is a hash value of the program.
